(19) United States
(12) Patent Application Publication
(10) Pub. No.: US 2016/0188261 A1
(43) Pub. Date: Jun. 30, 2016

(54) PRINTING APPARATUS, METHOD FOR CONTROLLING PRINTING APPARATUS, AND STORAGE MEDIUM

(71) Applicant: CANON KABUSHIKI KAISHA, Tokyo (JP)

(72) Inventor: Satoshi Totsuka, Toride-shi (JP)

(21) Appl. No.: 14/977,345

(22) Filed: Dec. 21, 2015

(30) Foreign Application Priority Data
Dec. 25, 2014 (JP) 2014-263175

(51) Int. Cl. G06F 3/12; G06K 15/00

(52) U.S. Cl. CPC G06F 3/1204; G06F 3/1254; G06F 3/1257; G06F 3/1258; G06F 3/1274; G06F 3/1297; G06K 15/404

(57) ABSTRACT

A printing apparatus includes a binding processing unit that executes a binding process, a reader unit that reads an image of an original document and generates image data, and a printer unit that prints an image on a sheet based on the image data generated by the reader unit. When a binding process is executed on the sheet on which the image has been printed by the printer unit, information related to a binding position of the binding process is stored and when a binding process is executed in an off-line mode, settings for the binding position are made based on the information are stored.

### BACKGROUND

1. Field

Aspects of the present invention generally relate to a printing apparatus that can process a sheet.

2. Description of the Related Art

Conventionally, a sheet processing apparatus that processes a sheet is known. As illustrative examples of sheet processing, binding processing to bind a plurality of sheets with a staple (a stapling process), and a staple-free binding process to bind a plurality of sheets by fastening without a staple (a staple-free stapling process) have been known.

As an example of the sheet processing apparatus, there is an apparatus used as a part of a printing apparatus that prints an image on a sheet. When a sheet processing apparatus is used as a part of a printing apparatus, the sheet processing apparatus is connected on a downstream side of the printing apparatus main unit in a sheet conveyance direction. Then, the sheet processing apparatus receives, from the printing apparatus main unit, a sheet on which an image is printed, and executes sheet processing on the sheet.

Further, there is also known sheet processing apparatuses that can execute sheet processing without printing an image by a printing apparatus main unit in addition to sheet processing executed together with image printing by the printing apparatus main unit. Japanese Patent Application Laid-Open No. 2014-162590 and Japanese Patent Application Laid-Open No. 2014-115425 discuss printing apparatuses that have a function of executing sheet processing together with image printing by the printing apparatus main unit and a function of executing sheet processing without image printing by the printing apparatus main unit.

As a use case of “executing sheet processing without image printing by the printing apparatus main unit” function, there may be a following case, for example. It is assumed that a user has one ten-sheet document bound with a staple at one position at a top right corner of the document. The user desires to make copies of this document and get five copies including the original document (i.e., four copies are newly made) which are each bound at one position at the top right corner in the same manner as the original document.

In this case, the user firstly removes the staple of the original document and sets the ten sheets on a reader unit. Then, the user makes settings for stapling at one position at the top right corner and sets “4” as the number of copies to make. When a start button is pressed, four copies, which are bound with a staple at the top right corner, are provided. The last one copy is made by re-stapling at the top right corner of the original document from which the staple has been removed. When re-stapling the last one copy, the function of “executing sheet processing without image printing by the printing apparatus main unit” is used.

However, there is a problem that it takes time and labor to make settings for re-stapling the original document using the function of “executing sheet processing without image printing by the printing apparatus main unit.” More specifically, it takes time and labor to select a stapling position if a plurality of stapling positions such as “top right corner,” “bottom right corner,” and “double” can be selected in the function of “executing sheet processing without image printing by the printing apparatus main unit.” Further, when a wrong position is selected, it causes a difference in stapling positions between the four newly made copies and the original document. Further, in addition to the problem of stapling positions, when there are both stapling methods of stapling with a staple and stapling without a staple, there is also a problem that it takes time and labor to select a method to be used.

### SUMMARY

Aspects of the present invention are generally directed to a mechanism that can simplify operation for binding a plurality of sheets read to make a copy.

According to an aspect of the present invention, a printing apparatus includes a binding processing unit configured to execute binding processing, a reading unit configured to read an image on an original document and generate image data, a printing unit configured to print an image on a sheet based on the image data generated by the reading unit, a storing unit configured to, in a case where the binding processing is executed on the sheet on which the image has been printed by the printing unit, store information related to a content of the binding processing, and a setting unit configured to, in a case where the binding processing is executed by the biding processing unit without printing an image by the printing unit, make settings for the binding processing based on the information stored in the storing unit.

Further features of the present disclosure will become apparent from the following description of exemplary embodiments with reference to the attached drawings.

### BRIEF DESCRIPTION OF THE DRAWINGS

FIG. 1 is a hardware block diagram illustrating a printing apparatus according to an exemplary embodiment.

FIG. 2 is a sectional view illustrating the printing apparatus according to the exemplary embodiment.

FIG. 3 is a perspective view illustrating a finisher according to the exemplary embodiment.

FIG. 4 is a perspective view illustrating an operation unit of the printing apparatus according to the exemplary embodiment.

FIGS. 5A and 5B are operation screens each displayed on the operation unit of the printing apparatus according to the exemplary embodiment.

FIG. 6 is a perspective view illustrating the operation unit of the printing apparatus according to the exemplary embodiment.

FIG. 7 is a flowchart illustrating an operation of the printing apparatus according to the exemplary embodiment.

FIG. 8 is a flowchart illustrating an operation of the printing apparatus according to the exemplary embodiment.

### DESCRIPTION OF THE EMBODIMENTS

Hereinafter, an exemplary embodiment of the present invention will be described in detail with reference to the drawings. An exemplary embodiment described below is not intended to limit aspects of the present invention according to claims and the means for solving the problem according to the aspects of the present invention do not necessarily require all of the combinations of the features described in the exemplary embodiment.

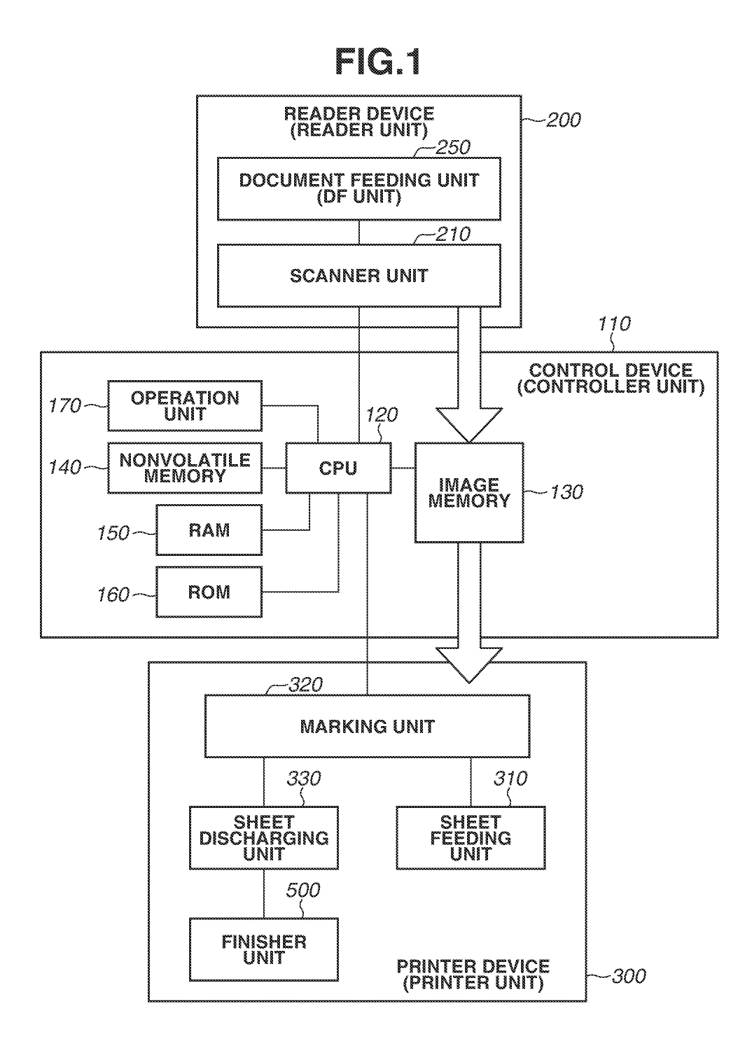

First, with reference to FIG. 1, an entire configuration of a printing apparatus according to an exemplary embodiment will be described. A reader unit (i.e., image reading unit) 200 optically reads a document image and converts the read image into image data. The reader unit 200 includes a scanner unit 210 having a function of reading a document and a document feeding unit (DF unit) 250 having a function of conveying a document sheet.

A printer unit (i.e., image output unit) 300 conveys a sheet, prints image data as a visible image thereon, and discharges the sheet outside the printing apparatus. The printer unit 300 includes a sheet feeding unit 310 including a plurality of cassettes and a marking unit 320 having a function of transferring and fixing image data on a sheet. The printer unit 300 further includes a sheet discharging unit 330 having a function of outputting a sheet on which an image is printed to the outside of the printing apparatus and a finisher unit 500 for performing a stapling process and a sorting process.

A control device 110 includes a central processing unit (CPU) 120, an image memory 130, a nonvolatile memory 140, a random-access memory (RAM) 150, a read-only memory (ROM) 160, and an operation unit 170. The control device 110 is electrically connected to the reader unit 200 and the printer unit 300. The CPU 120 in the control device 110 provides a copy function by controlling the reader unit 200 to read document image data into the image memory 130 and by controlling the printer unit 300 to print the image data read into the image memory 130 on a sheet.

Here, in the control device 110, one CPU 120 executes each process illustrated in a flowchart described below using one memory (RAM 150); however, other exemplary embodiments may be employed. For example, a plurality of CPUs or a plurality of RAMs, and a hard disk drive (HDD) or a solid state drive (SSD) may be caused to operate in a cooperative manner to execute each process. Further, a part of processes described below may be executed by a hardware circuit such as an application specific integrated circuit (ASIC).

The nonvolatile memory 140 stores various adjustment values. The RAM 150 is used as a work area of the CPU 120. The ROM 160 stores a control program of the CPU 120. The operation unit 170 includes a liquid crystal display unit, a touch panel input device attached on the liquid crystal display unit, and a plurality of hard keys. Signals input via the touch panel or the hard keys are transmitted to the CPU 120, and the liquid crystal display unit displays functions or image data related to operation of the entire printing apparatus.

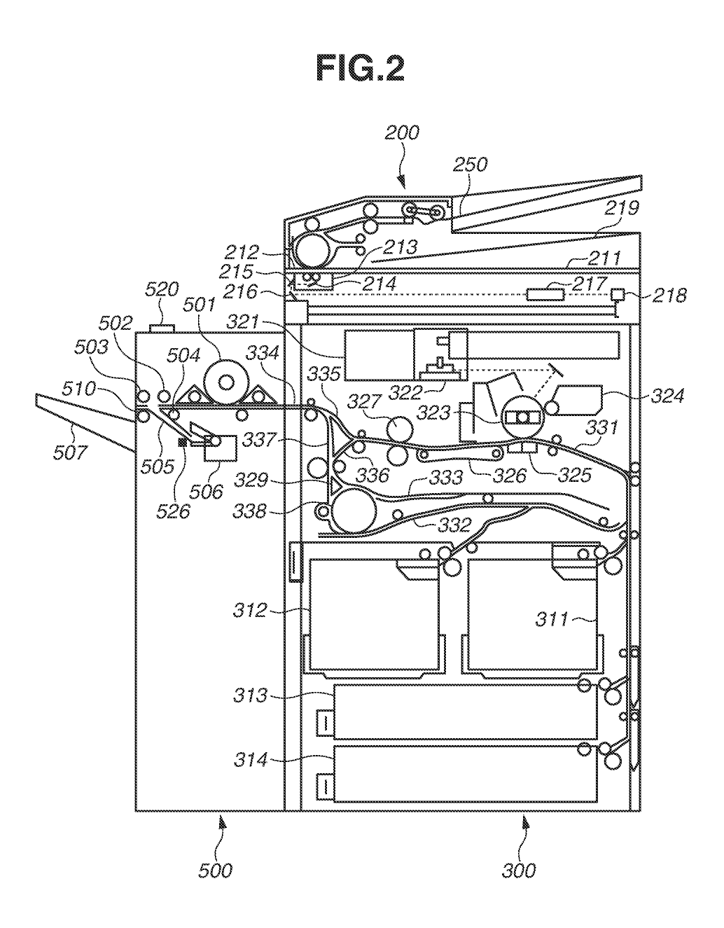

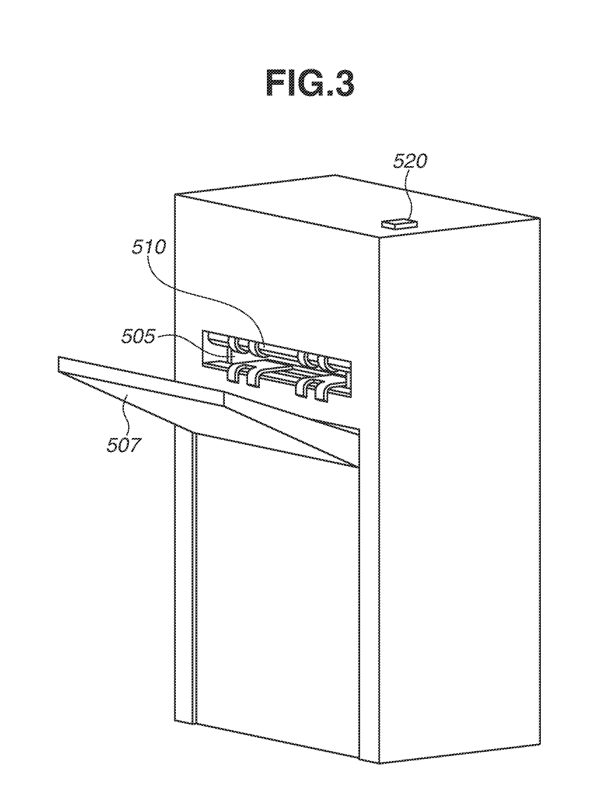

Next, with reference to FIGS. 2 and 3, the reader unit 200, the printer unit 300, and the finisher unit 500 according to the present exemplary embodiment will be described. In the reader unit 200, the document feeding unit (feeder) 250 feeds original document sheets from the beginning one by one at a time onto a platen glass 211, and when a scan operation of the original document is finished, the original document on the platen glass 211 is discharged to the discharge tray 219. When the original document is conveyed onto the platen glass 211, a lamp 212 is turned on, and an optical unit 213 starts to move to perform exposure-scanning of the original document. Reflecting light from the original document is led to a charged-couple device image sensor (hereinafter, referred to as a CCD) 218 via mirrors 214, 215, and 216 and a lens 217. In this manner, the scanned image of the original document is read by the CCD 218. Image data output from the CCD 218 is transferred to the control device 110 after a predetermined process is performed thereon.

Next, the printer unit 300 will be described. In the printer unit 300, a laser driver 321 drives a laser emitting unit 322 and causes the laser emitting unit 322 to generate laser beam corresponding to the image data output from the control device 110. This laser beam is radiated to a photosensitive drum 323 and a latent image corresponding to the laser light is formed on the photosensitive drum 323. On the area of the latent image on the photosensitive drum 323, developer is applied by a development device 324.

Further, the printer unit 300 includes, as a sheet feeding unit 310, cassettes 311, 312, 313, and 314 which are respectively in a shape of a drawer. The printer unit 300 feeds a sheet from one of the cassettes 311, 312, 313, and 314 and conveys the sheet to a transfer unit 325 via a conveyance path 331. The transfer unit 325 transfers the developer attached on the photosensitive drum 323 to the sheet. The sheet to which the developer has been transferred is conveyed to a fixing unit 327 by a conveyance belt 326. Here, the developer is fixed on the sheet by heat and pressure of the fixing unit 327. After that, the sheet, which has passed through the fixing unit 327, passes through conveyance paths 335 and 334 and is discharged outside the apparatus. Alternatively, if the sheet is discharged after the printed side is reversed, the sheet is led to conveyance paths 336 and 338 and conveyed in the reverse direction to discharge via conveyance paths 337 and 334.

Further, in a case that two-sided printing is set, after the sheet passes through the fixing unit 327, a flapper 329 leads the sheet from the conveyance path 336 to a conveyance path 333, then the sheet is conveyed in a reverse direction and the flapper 329 leads the sheet from the conveyance path 338 to a re-feed conveyance path 332. The sheet led to the re-feed conveyance path 332 passes through the conveyance path 331 at the timing described above and fed to the transfer unit 325. Regardless of one-sided forming or two-sided forming, the sheet discharged from the conveyance path 334 is conveyed to the finisher unit 500.

Next, the finisher unit 500 will be described. FIG. 3 is a perspective view illustrating the finisher unit 500. Here described is an example of the finisher unit 500 having a stapling function of binding a plurality of sheets with a staple. However, aspects of the present invention are not limited thereto. For example, the function may be a staple-free stapling function of binding sheets by fastening without a staple, or a function of bookbinding, gluing, folding, or punching. The sheet conveyed to the finisher unit 500 is firstly sent to a buffer unit 501. The buffer unit 501 is used when the conveyed sheet is buffered. For example, in a case that a stapling process which is performed downstream thereof takes time, the buffer unit is used to keep the conveyance speed of the sheet conveyed from the apparatus constant and this helps to improve the throughput. Then, the sheet passes through the discharge port 510 via an upstream discharge roller pair 502 and a downstream discharge roller pair 503 and is discharged to a discharge tray 507.

Further, in a case that stapling is specified as sheet processing to be performed after printing, immediately after an rear edge of the sheet conveyed by the upstream discharge roller pair 502 passes therethrough, the sheet is pulled back by a knurled belt 504 and discharged to a stack tray 505. Then, after a predetermined number of sheets are stacked, a stapling unit 506 performs a stapling process thereon, and the stapling-processed sheets are discharged to the discharge tray 507 by the downstream discharge roller pair 503. Further, in a case of shift sorting, the sheets stacked on the stack tray are discharged in a state of being shifted to left or right so that the separation of copies can be easily distinguished.

Further, in addition to the normal stapling, there is an off-line mode in which, when a user inserts a bundle of sheets directly to the stack tray 505 and a sheet bundle detection sensor 526 detects the bundle of sheets, the stapling unit 506 staples the bundle of sheets on the stack tray 505. The off-line mode is controlled based on an operation via an off-line mode operation unit 520 provided on the top of the finisher unit 500.

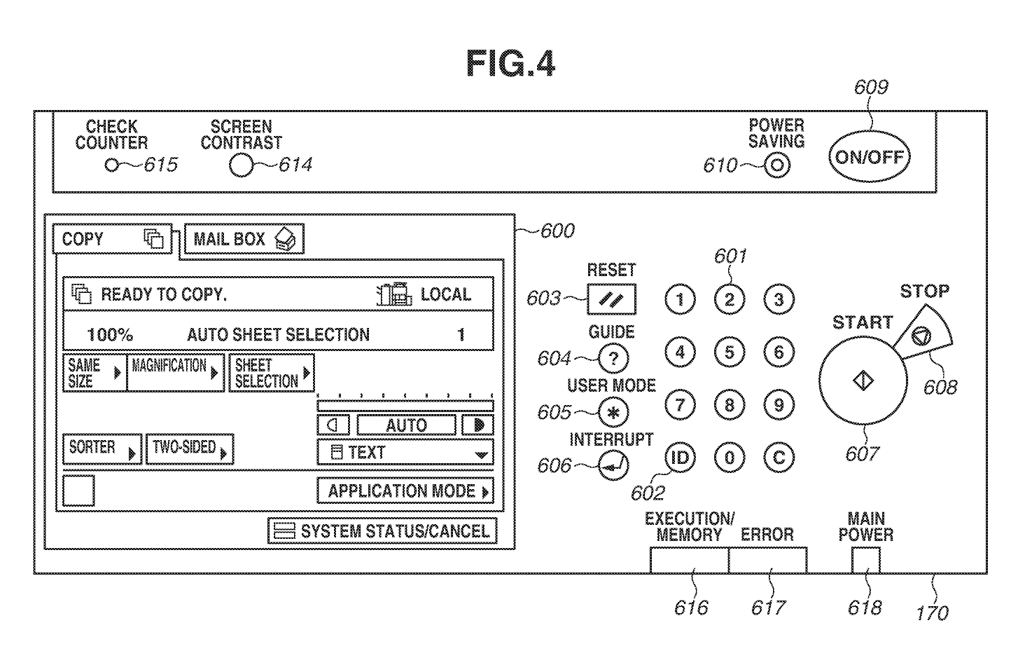

Next, with reference to FIG. 4, the operation unit 170 illustrated in FIG. 1 will be described. A liquid crystal display (LCD) touch panel 600 is used to set main modes and displays conditions. A numeric keypad 601 is used to input numerical values from zero to nine. An identification (ID) key 602 is used to input a division number and a password in a case where a division management is performed in the apparatus.

A reset key 603 is used to reset the set mode. A guide key 604 is used to display a description screen of each mode. A user mode key 605 is used to start a user mode screen. An interruption key 606 is used to execute an interruption copy.

A start key 607 is used to start a copy operation. A stop key 608 is used to cancel a copy job under execution. A software power switch 609 is pressed to shift a state of the apparatus to a low-power state with a back light of the LCD 600 turned off. A power saving key 610 is pressed to start a power saving state and is pressed again to recover from the power saving condition.

An adjustment key 614 is used to adjust the contrast of the LCD touch panel. A counter check key 615 is pressed to display, on the LCD, a count screen for displaying a total number of executed copies. A light-emitting diode (LED) 616 indicates that a job is being executed or an image is being stored into the image memory. An error LED 617 indicates that the apparatus is in an error condition due to a paper jam, a cover being open, or the like. A power LED 618 indicates that the main switch of the apparatus is turned on.

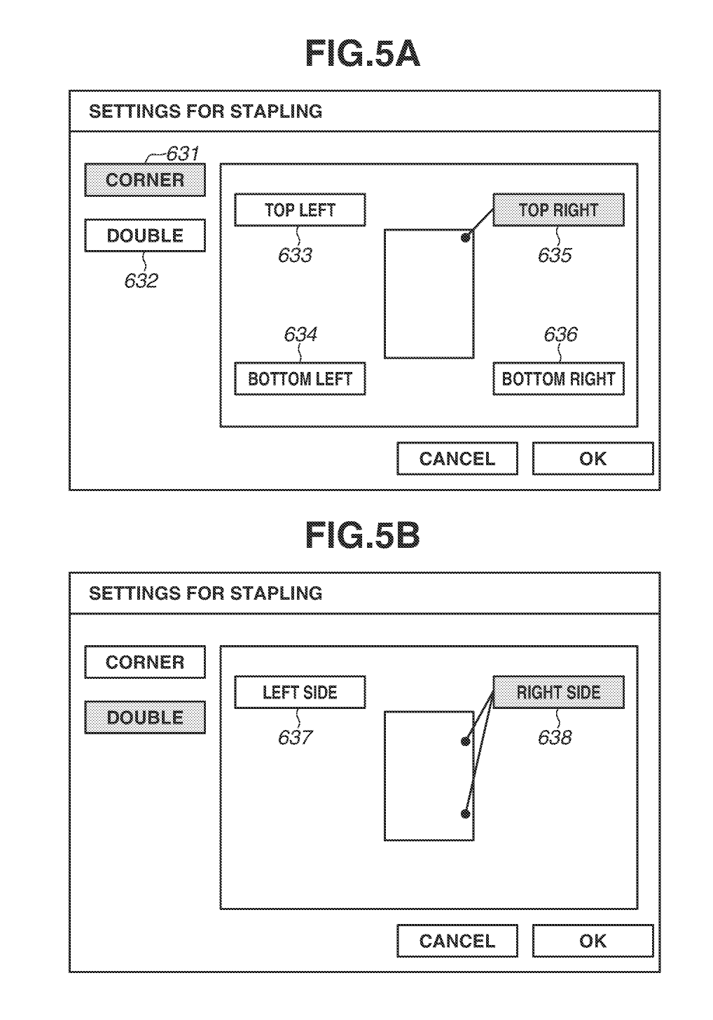

FIGS. 5A and 5B are operation screens that can be displayed on the LCD touch panel 600. The illustrated screens are screens for performing settings related to stapling processing to be executed after printing performed by the printer unit 300. In this example, only settings related to stapling with a staple will be described; however, staple-free stapling, bookbinding, gluing, folding, and punching can be set on a different screen.

A key 631 is pressed when stapling the sheets at a single position at a corner. A key 632 is pressed when stapling the sheets at two positions along one side. When the key 631 is pressed, the screen illustrated in FIG. 5A is displayed, and the user can select one of the four corners to bind. Keys 633, 634, 635 and 636 are keys for specifying the top left, the bottom left, the top right, and the bottom right, respectively. FIG. 5A illustrates a state that the top right has been selected.

When the key 632 is pressed, the screen illustrated in FIG. 5B is displayed, and the user can select one of the right side and the left side to bind. The keys 637 and 638 are keys for specifying the left side and the right side, respectively. FIG. 5B illustrates a state that the right side has been selected.

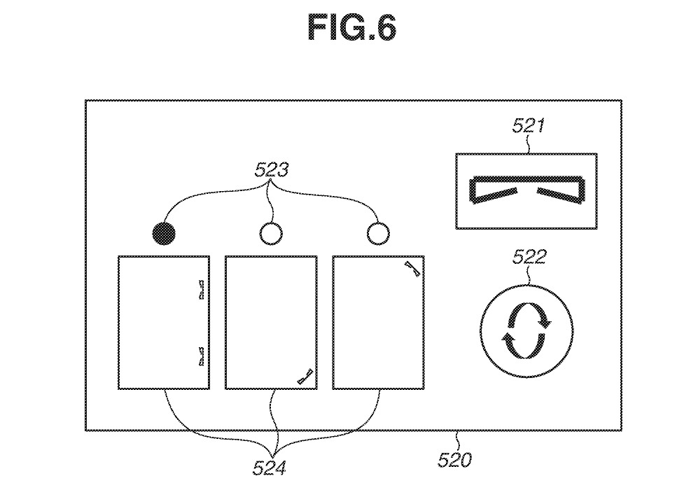

Next, with reference to FIG. 6, the operation unit 520 provided in the finisher unit 500 will be described in detail. A mode key 522 is used to start an off-line mode for executing a stapling process without printing. The mode key 522 is also used to select a position of stapling performed in the off-line mode.

In the finisher unit 500, as indicated by the reference 524, the stapling positions can be selected from three options of “double,” “bottom right corner,” and “top right corner.” When the mode key 522 is firstly pressed, the default value of “double” is selected. Then, every time the mode key 522 is pressed, the selection is switched to “bottom right corner,” “top right corner,” “double,” and so on in a toggle state. Light emitting portions (LED lamps) 523 indicate a currently selected mode, and in the illustrated example, “double” is selected.

An execution key 521 is operated by the user to make an instruction for executing the stapling process. When the execution key 521 is pressed after pressing the mode key 522 and inserting a bundle of sheets to the stack tray 505, a stapling process is executed. It is assumed that the off-line mode is cancelled immediately after the stapling process is executed. However, the off-line mode may be cancelled by a user's operation or after a predetermined period of time has passed. In a case where the off-line mode is to be cancelled by the user's operation or after a predetermined period of time has passed, the selection of the stapling position is maintained as it is.

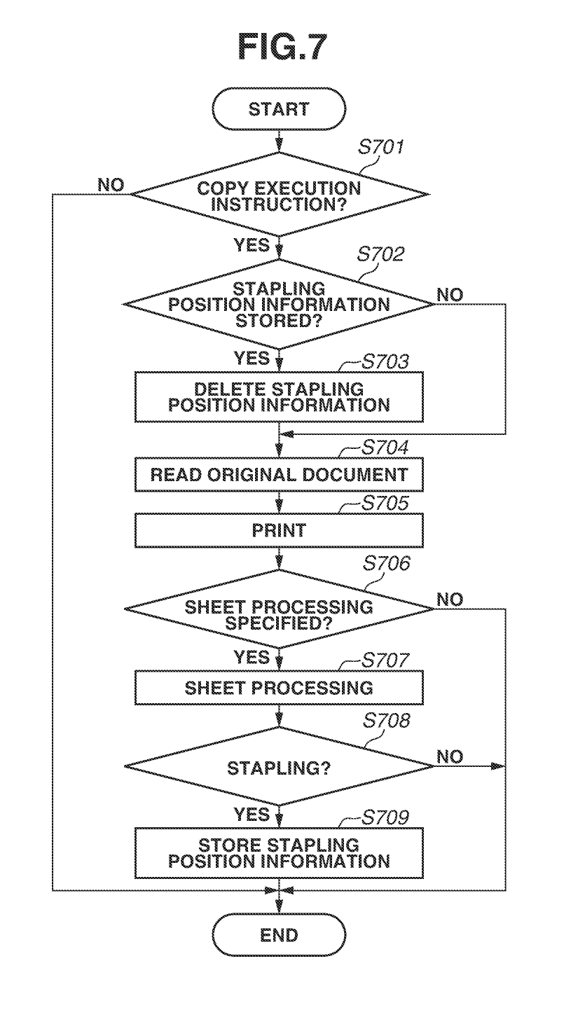

FIG. 7 is a flowchart illustrating an operation for executing a copy process. Each operation (step) illustrated in the flowchart of FIG. 7 is realized by the CPU 120 executing control programs stored in the ROM 160.

In step S701, it is determined whether a copy execution instruction has been received from the user. The user can instruct to execute a copy job by pressing the start key 607 after selecting the copy function. When it is determined that a copy execution instruction has been received (Yes in step S701), the processing proceeds to step S702. On the other hand, when it is determined that a copy execution instruction has not been received (No in step S701), the processing is ended.

In step S702, it is determined whether stapling position information has been stored in the RAM 150. The storing of stapling position information will be described below in step S709. When it is determined that the stapling position information has been stored (Yes in step S702), the processing proceeds to step S703. On the other hand, when it is determined that stapling position information has not been stored (No in step S702), the processing proceeds to step S704. In step S703, the stored stapling position information is deleted.

In step S704, document is read and image data is generated based on the image of the document. In step S705, printing is executed on the sheet based on the image data generated in step S704. In step S706, it is determined whether an execution of sheet processing for the sheet on which the image has been printed has been specified. When it is determined that an execution of sheet processing has been specified (Yes in step S706), the processing proceeds to step S707. When it is determined an execution of sheet processing has not been specified (No in step S706), the processing is ended.

In step S707, the specified sheet processing is executed. Here, one of stapling with a staple, staple-free stapling, bookbinding, gluing, folding, and punching is executed. In step S708, it is determined whether the sheet processing executed in step S707 is stapling. When it is determined the executed sheet processing is stapling (Yes in step S708), the processing proceeds to step S709. When it is determined the executed sheet processing is not stapling (No in step S708), the processing is ended.

In step S709, the stapling position information indicating the position where the stapling process has been executed is stored in the RAM 150. The stapling position information includes information indicating “corner” or “double,” and further includes, in a case where “corner” is selected, information indicating one of “top left,” “bottom left,” “top right,” or “bottom right”.

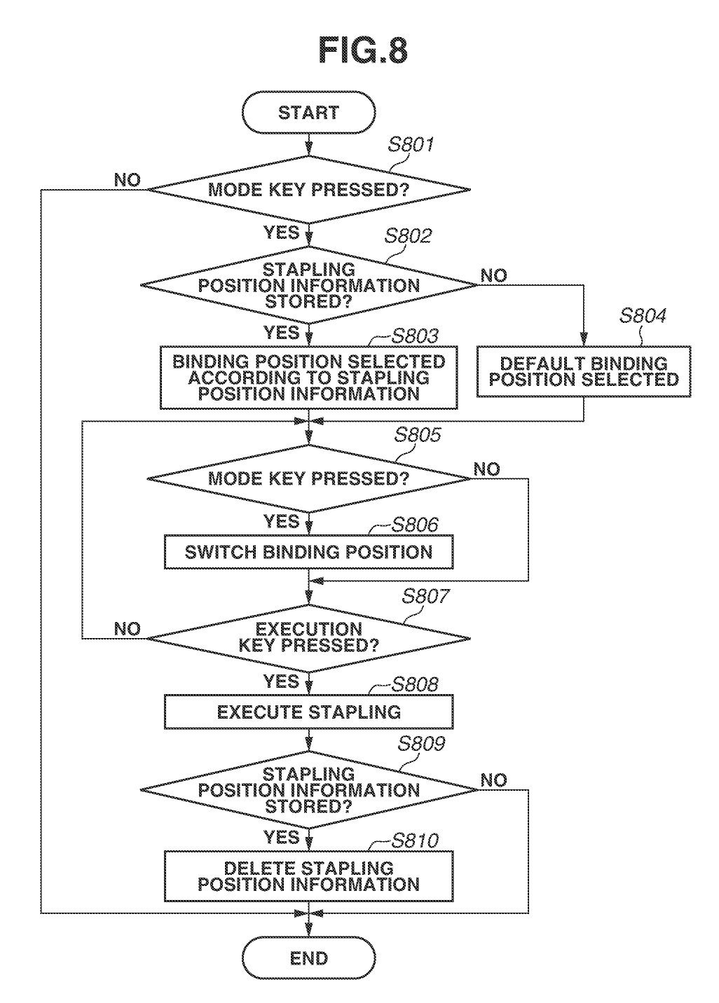

Next, FIG. 8 is a flowchart illustrating an operation for executing a stapling process in the off-line mode. Each operation (step) illustrated in the flowchart of FIG. 8 is realized by the CPU 120 executing control programs stored in the ROM 160.

In step S801, it is determined whether the mode key 522 has been pressed. When it is determined that the mode key 522 has been pressed (Yes in step S801), the processing proceeds to step S802, and when it is determined that the mode key 522 has not been pressed (No in step S801), the processing is ended. In step S802, it is determined whether stapling position information has been stored in the RAM 150. When stapling position information has been stored, the stapling position information is the information stored in step S709 in FIG. 7. When it is determined that stapling position information has been stored (Yes in step S802), the processing proceeds to step S803, and when it is determined that stapling position information has not been stored (No in step S802), the processing proceeds to step S804.

In step S803, according to the stored stapling position information, a binding position is set. More specifically, when the stapling position information indicates “double,” “double” is selected as illustrated in the left in FIG. 6. When the stapling position information indicates “top left” or “bottom right” of “corner,” “bottom right corner” illustrated in the middle in FIG. 6 is selected. When the stapling position information indicates “top right” or “bottom left” of “corner,” “top right corner” illustrated in the right in FIG. 6 is selected.

With this configuration, in a case that a stapling process with settings of “double” and “right side” is to be executed in step S707, the stapling process is executed at the same position as the copied and stapled sheets when the bundle of original documents is set so as to have its front side facing upward and the upper side of the image on a farther side. Further, in a case that a stapling process with settings of “double” and “left side” is to be executed in step S707, the stapling process is executed at the same position as the copied and stapled sheets when the bundle of original documents is set so as to have its front side facing upward and the upper side of the image on a closer side. In this example, the “closer side” represents a side closer to the position where the user stands with respect to the printing apparatus.

Further, in a case that a stapling process with settings of “top right” or bottom right” of “corner” is to be executed in step S707, the stapling process is executed at the same position as the copied and stapled sheets when the bundle of original documents is set so as to have its front side facing upward and the upper side of the image on a farther side. Further, in a case that a stapling process with settings of “top left” or “bottom left” of “corner” is to be executed in step S707, the stapling process is executed at the same position as the copied and stapled sheets when the bundle of original documents is set so as to have its front side facing upward and the upper side of the image on a closer side.

In this manner, since the stapling position selection state in the operation unit 520 is automatically switched based on the stapling position information stored in step S709, user's time and labor of making selection is reduced and selection of wrong stapling position can be prevented.

In step S804, it is set in a state that a default binding position is selected. In this example, it is assumed that it is set in a state that “double,” i.e., default binding position, (as illustrated in the left side in FIG. 6) is selected. In step S805, it is determined whether the mode key 522 has been pressed. When it is determined that the mode key 522 has been pressed (Yes in step S805), the processing proceeds to step S806, and when it is determined that the mode key 522 has not been pressed (No in step S805), the processing proceeds to step S807.

In step S806, the selected stapling position is switched. More specifically, when “double” is currently selected, it is switched to a state that “bottom right corner” is selected. Further, when “bottom right corner” is currently selected, it is switched to a state that “top right corner” is selected. In addition, when “top right corner” is currently selected, it is switched to a state that “double” is selected. In this manner, the binding position which is automatically set in step S803 can be changed by the user.

In step S807, it is determined whether the execution key 521 has been pressed. When it is determined that the execution key 521 has been pressed (Yes in step S807), the processing proceeds to step S808, and when it is determined that the execution key 521 has not been pressed (No in step S807), the processing returns to step S805. In step S808, the stapling process is executed at the selected position (“double,” “bottom right corner,” or “top right corner”).

In step S809, it is determined whether stapling position information has been stored in the RAM 150. When it is determined that stapling position information has been stored (Yes in step S809), the processing proceeds to step S810, and when it is determined that stapling position information has not been stored (No in step S809), the processing is ended. In step S810, the stored stapling position information is deleted.

As described above, in a case where a stapling process is executed on the sheets on which an image is printed by the printer unit 300, the printing apparatus stores information related to a binding position of the stapling process in the RAM 150. Then, in a case where a stapling process is executed without image printing by the printer unit 300, the binding position setting is performed based on the information stored in the RAM 150. With this configuration, an operation to bind the plurality of sheets which have been read to make a copy can be simplified.

Here, the stapling position information is deleted in step S703 because it is assumed that a copy job is executed without executing an off-line mode stapling process after a previous copy job is executed. In other words, when a following copy job is executed without executing an off-line mode stapling process, the information related to the stapling process of the previous copy job is no longer needed and the information is deleted.

Further, the stapling position information is deleted in step S810 because it is assumed that a stapling process may be desired to be made in an off-line mode in the same manner of the copied and stapled sheets only once in one copy job. In other words, once an off-line mode stapling process is executed based on the stapling position information stored in the RAM 150, the stapling position information is deleted since the information is no longer needed.

In the above-described exemplary embodiment, an example that the information that indicates “corner” or “double”, and, in a case of “corner,” further information that indicates one of “top left,” “bottom left,” “top right,” or “bottom right” are stored in the RAM 150 as stapling position information. As a substitute of the above, “double,” “bottom right corner,” or “top right corner” may be selected based on the binding position of the stapling process executed in step S707, and the information that indicates the selected binding position may be stored in the RAM 150 as stapling position information.

Further, using the screen illustrated in FIGS. 5A and 5B or on the operation unit 520 illustrated in FIG. 6, selecting whether a stapling process with a staple or a stapling process without a staple is executed may be made as a content of the sheet processing. In this case, the information indicating which process has been executed in step S707 is stored to the RAM 150 in step S709, and, in step S803, one of the stapling process with a staple and a stapling process without a staple is automatically set based on the information stored in the RAM 150. Here, even when the user specifies a stapling process without a staple on the screen illustrated in FIGS. 5A and 5B, because of the upper limit number of sheets which can be processed, a stapling process with a staple is executed in step S707 and information that indicates the stapling process with a staple is stored in step S709.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2014-263175, filed Dec. 25, 2014, which is hereby incorporated by reference herein in its entirety.

What is claimed is:

1. A printing apparatus comprising:
a binding processing unit configured to execute binding processing;
a reading unit configured to read an image on an original document and generate image data;
a printing unit configured to print an image on a sheet based on the image data generated by the reading unit;
a storing unit configured to, in a case where the binding processing is executed on the sheet on which the image has been printed by the printing unit, store information related to a content of the binding processing; and
a setting unit configured to, in a case where the binding processing is executed by the binding processing unit without printing an image on a sheet by the printing unit, make settings for the binding processing based on the information stored in the storing unit.

2. The printing apparatus according to claim 1, wherein, when a mode is switched to a mode in which the binding processing is executed by the binding processing unit without printing an image on a sheet by the printing unit, the setting unit makes the settings.

3. The printing apparatus according to claim 1,
wherein the information stored in the storing unit is information related to a binding position of the executed binding processing, and
wherein the setting unit makes settings for the binding position based on the information stored in the storing unit.

4. The printing apparatus according to claim 1,
wherein the information stored in the storing unit is information that indicates whether the executed binding processing is binding processing with a staple or binding processing without a staple, and
wherein the setting unit makes settings regarding whether to execute binding processing with a staple or binding processing without a staple based on the information stored in the storing unit.

5. The printing apparatus according to claim 1, wherein the settings made by the setting unit can be changed by a user.

6. The printing apparatus according to claim 1, further comprising a deletion unit configured to delete information stored in the storing unit in a case where binding processing without printing an image on a sheet by the printing unit is executed by the binding processing unit.

7. The printing apparatus according to claim 1, wherein the binding processing unit executes binding processing according to a user's instruction after the setting unit makes the settings.

8. The printing apparatus according to claim 1, wherein the original document read by the reading unit is bound via the binding processing executed without printing an image on a sheet by the printing unit.

9. A method for controlling a printing apparatus, the method comprising:
executing binding processing;
reading an image on an original document and generating image data;
printing an image on a sheet based on the generated image data;
storing, in a case where the binding processing is executed on the sheet on which the image has been printed, information related to a content of the binding processing; and
making, in a case where the binding processing is executed without printing an image on a sheet, settings for the binding processing based on the stored information.

10. A non-transitory computer-readable storage medium storing computer executable instructions that cause a computer to perform a method for controlling a printing apparatus, the method comprising:
executing binding processing;
reading an image on an original document and generating image data;
a printing process for printing an image on a sheet based on the generated image data;
storing, in a case where the binding processing is executed on the sheet on which the image has been printed, information related to a content of the binding processing; and
making, in a case where the binding processing is executed without printing an image on a sheet settings for the binding processing based on the stored information.
